(19) United States
(12) Patent Application Publication
(10) Pub. No.: US 2004/0005391 A1
(43) Pub. Date: Jan. 8, 2004

(54) Sandwich preparation method

(76) Inventor: Charles M. Shin, Dublin, OH (US)

Correspondence Address: Frank H. Foster, KREMBLAS, FOSTER, PHILLIPS & POLLICK, 7632 Slate Ridge Blvd., Reynoldsburg, OH, 43068, US

(21) Appl. No.: 10/188,485

(22) Filed: Jul. 3, 2002

(51) Int. Cl. A23G 1/00

(52) U.S. Cl. 426/275

(57) ABSTRACT

A sandwich is prepared by initiating toasting two layers of baked bread concurrently with grilling sandwich contents on a griddle, and then disposing the sandwich contents on a surface of at least one of the layers of bread. An impinging oven performs the toasting step, and the bread has been lightly baked prior to the toasting step. The method yields a heated sandwich while avoiding the loss of flavor often coincident to volume production.

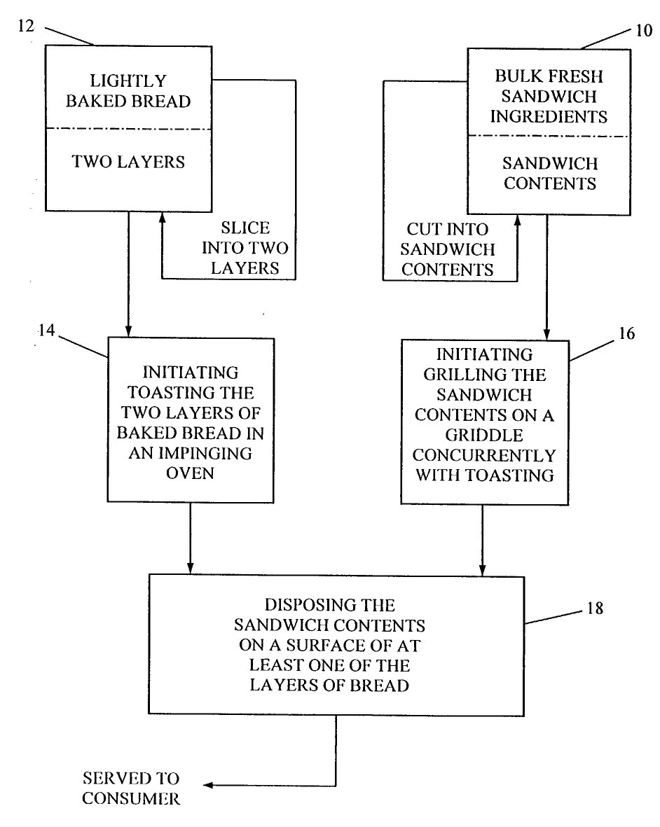

### BACKGROUND OF THE INVENTION

1. Field of the Invention

This invention relates generally to a process to be used in preparing a sandwich for human consumption, and more particularly relates to a process for rapidly and efficiently preparing sandwich contents and bread for a heated sandwich while avoiding the loss of flavor often coincident to volume production.

2. Description of the Related Art

A sandwich has long been one of the most popularly consumed foods in the world, primarily because it can be made from a variety of ingredients for satisfying most tastes and diets. In recent years, that popularity has greatly increased, especially across the United States among consumers who demand foods that can be quickly and easily prepared, transported, and consumed. In order to meet the demand for a quality sandwich, and at the same time to meet the traditional American demand for fast, convenient service, it is necessary to supply a large number of relatively small restaurants and carry out installations with a variety of ingredients having maximum quality, freshness, and appeal. The supply of ingredients has to be replenished regularly, even if a previous supply is not completely exhausted, for guaranteeing the freshness of ingredients for each consumer.

In order to operate a restaurant profitably, persons who do not have extensive training often perform the preparation of a sandwich for consumption by consumers. These relatively untrained and unskilled people must be able to consistently prepare a high quality sandwich. Meeting this need is a challenge for the restaurant, because using all fresh ingredients is labor intensive and increases production costs. A large amount of fresh ingredients must be prepared substantially daily for assembling into a large volume of sandwiches. A sufficient number of sandwiches must be sold to exhaust the supply of fresh ingredients over a predictable time period in order to avoid waste. The sandwiches produced must consistently appeal to consumers, who will then be more likely to regularly patronize the restaurant. Therefore, the use of fresh ingredients and relatively unskilled workers requires a method for making sandwiches that is easily and predictably performed in order to provide consistently high quality products.

The restaurant may seek to minimize the production costs and risk of waste by preparing the fresh sandwich contents only after they are ordered, rather than at the start of each day or the evening prior to each day. However, cutting each ingredient from a bulk source as each sandwich is ordered extends the preparation time for the sandwich substantially beyond what a consumer will tolerate. Attempts to shorten the preparation time may compromise the freshness of the ingredients, such as by using pre-packaged ingredients that require substantially no preparation time. Often, a restaurant will utilize a combination of both fresh and pre-packaged ingredients for making a sandwich, in an effort to decrease preparation time and production costs, yet still produce an appealing sandwich.

Consumers who desire a heated sandwich made from fresh ingredients impose even greater challenges on the restaurant. Generally, the challenges include determining how to quickly prepare and serve the heated sandwich in a way that preserves the individual flavors of the fresh ingredients. Several sandwich-making methods are known, but none solves those problems.

For example, the prevalent practice in commercial production of heated sandwiches is to combine cold sandwich contents, such as deli meat and cheese, between two layers of bread. The combination is placed in an oven and heated. However, the surfaces of the bread that are in contact with the sandwich contents do not become heated, because the heat cannot sufficiently penetrate the bread to reach those surfaces. In fact, the bread typically becomes soggy due to moisture from the sandwich contents soaking into those surfaces. In order to heat the surfaces of the bread that are in contact with the sandwich contents, the combination must remain in the oven for an extended period of time, which usually results in the outer surfaces of the bread becoming burnt and brittle.

A more time-consuming method of making a heated sandwich is to first cook the sandwich contents before disposing them between two layers of bread, or on a surface of one of the layers. Cheese is placed on top of the cooked sandwich contents, and the combination is placed in an oven for heating. However, although the sandwich contents are cooked, this method fails to heat all surfaces of the bread, because the heat cannot sufficiently penetrate the bread to reach those surfaces that are in contact with the sandwich contents. If the cooked sandwich contents are placed on a surface of one of the layers of bread, and the combination is heated as an “open-faced” sandwich, then the heat cannot sufficiently penetrate the sandwich contents to reach the surface of the bread underneath the sandwich contents. Also, moisture released from the sandwich contents during cooking accumulates on the sandwich contents and is absorbed by the bread, which becomes soggy. Decreasing the amount of the sandwich contents that are disposed on the bread does not alleviate that problem, because any amount of the cooked sandwich contents contains enough moisture to make the bread soggy. Also, consumers prefer generous portions, so competitive forces in the marketplace prohibit decreasing the amount of the sandwich contents for an order. As an additional problem, this method permits the sandwich contents to easily fall off the bread while in the oven, so the combination requires a sheet of foil or similar heat-resistant structure for retaining the sandwich contents on the bread. Otherwise, pieces of the sandwich contents can accumulate in the oven, where they will smolder and combust, thereby becoming a fire hazard.

The traditional heated sandwich known as a “Philadelphia Cheese Steak Sandwich” is made by grilling the sandwich contents, and heating a bun, on a griddle. The bun is sliced longitudinally, and the cut faces are placed on the griddle, usually when the sandwich contents are nearly finished cooking. The prepared sandwich contents are then placed on the sides of the bun that were in contact with the griddle. Those sides usually become crispy, but only from being fried by the grease that was released from the cooking food or previously cooked food. The entire surface of the bun does not become crispy, and the flavor of the bun becomes masked by flavors and aromas absorbed from the griddle. About two minutes are required for heating the entire bun, because only one side of the bun is directly exposed to the griddle, and the heat is slowly drawn upwardly through the bun from only that one side.

It is therefore an object of the invention to provide an improved method for preparing a sandwich.

A further object of the invention is to provide a method of preparing a sandwich for consumption so that the sandwich has a maximum appeal to most tastes.

A further object of the invention is to provide a sandwich that is cooked to uniform perfection regardless of the lack of skill of the operator or the variation in the amount of the ingredients.

A further object of the invention is to provide a method for preparing a sandwich for consumption, which method may be efficiently practiced by a small, high-volume restaurant.

Further objects and features of the invention will be apparent from the following specification and claims when considered in connection with the accompanying drawing illustrating the invention.

### BRIEF SUMMARY OF THE INVENTION

The preparation of a sandwich is initiated by toasting two layers of lightly baked bread. Concurrently with toasting the two layers of bread, sandwich contents undergo grilling on a griddle. The sandwich contents are then disposed on a surface of at least one of the layers of bread. Preferably, an impinging oven performs the toasting step, and the bread is a submarine roll that has been lightly baked prior to the toasting step.

### BRIEF DESCRIPTION OF THE DRAWING

The FIGURE is a block diagram illustrating the steps of an embodiment of the invention.

In describing the embodiment of the invention, which is illustrated in the drawing, specific terminology will be resorted to for the sake of clarity. However, it is not intended that the invention be limited to the specific term so selected, and it is to be understood that each specific term includes all technical equivalents which operate in a similar manner to accomplish a similar purpose.

### DETAILED DESCRIPTION OF THE INVENTION

The FIGURE illustrates the preferred steps for preparing a heated sandwich for service to a consumer. Normally, initially fresh bulk sandwich ingredients 10 will be supplied to a restaurant installation in a raw or otherwise fresh condition. At the beginning of a day of operation, or each evening after the day of operation and prior to the next day, a sufficient quantity of the bulk ingredients 10 for one day's operation is prepared by cutting the ingredients 10 into a form suitable for use as sandwich contents.

During the day of operation, immediately after a consumer orders a sandwich, two layers of bread are prepared 12. Preferably, the bread is constituted by a submarine roll, which has a length much greater than its width. The roll is sliced lengthwise substantially in half in order to form the two layers, which remain joined along a common edge. The roll is “opened” by pivoting the halves outwardly on the common edge relative to one another for exposing opposing surfaces, which were formed by slicing the roll. Alternatively, two unconnected slices cut from a loaf of bread may constitute the bread. In any form, the layers of bread should be thick, for retaining moisture to resist excessive drying during toasting 14. The bread cannot be so thin that substantially all moisture is rapidly drawn out of each layer during toasting 14, thereby making the bread burnt or brittle.

It is preferred that the bread is lightly baked, or slightly under baked, prior to toasting 14. This means that the bread has not been fully baked, such as to an extent required by a recipe for the bread, or to an otherwise usual extent that bread is baked. In lightly baked bread, many of the chemical reactions that occur during the initial baking of the bread become suspended until the bread is again heated. Thus, the lightly baked bread undergoes some baking during toasting 14, which serves to enhance the appeal of the sandwich by maximizing the freshly baked flavor of the bread.

Although a toaster oven can be used, it is preferred that toasting 14 is performed using an impinging oven. Generally, the impinging oven has multiple heating elements oriented in several directions toward the layers of bread and an air impeller for forcing air over the heating elements and directing the heated air against the bread. It is most preferred that the impinging oven has a conveyor rack rotatingly engaged to the oven and extending between a front opening and a rear opening. The joined halves of the submarine roll are pivoted outwardly to one another and placed on the conveyor rack, thereby ensuring that the opposing surfaces become exposed to the heated air currents. Usually, the layers of bread are placed horizontally on the conveyor rack. However, the layers may be placed in another orientation, so long as the entire surface of each layer is surroundingly exposed to the heated air currents. For example, a conveyor rack may have individual receptacles for holding the layers of bread in a substantially vertical orientation on the rack, in order to orient the surfaces of each of the layers toward a direction from which the heated air currents are blown.

Toasting 14 is performed until the bread becomes surroundingly toasted, meaning that each layer has a toasted crust enveloping a center comprised of soft bread. During toasting 14, the heated air is impinged against the entire surface of each layer of bread, which absorbs the heat and becomes warmed thereby. The temperature of the surface increases before the heat moves inwardly and increases the temperature of the center region of the bread. Thus, the surface of the bread is heated more than the bread in the interior below the surface. The surrounding contact of heated air currents against the surface of each layer evenly draws much of the moisture outwardly from the bread underneath the surface. As a result, the toasted crust is formed extending from the surface to a substantially uniform depth beneath the surface. Moisture retained by the bread underneath the surface is drawn outwardly toward the surface and buffers the heat, thereby enabling the surface to withstand the heated air currents without becoming burnt or brittle. Initially, the bread underneath the surface softens, as it gets warmer.

Concurrently with toasting 14, sandwich contents undergo grilling 16 on a griddle. Preferably, meat and vegetables constitute the sandwich contents, but a variety of other sandwich contents may be used. Grilling 16 and toasting 14 are performed quickly, substantially in about one minute, so it is important that any meat is properly cooked in this short amount of time. This is aided by slicing the meat into thin strips and small pieces during, or prior to, grilling 16. A slice of cheese may be placed on top of the contents toward the end of grilling 16, while the contents are on the griddle.

The concurrent or simultaneous performance of the toasting of the bread in a toasting apparatus and the grilling of the sandwich contents on a griddle is critical to the present invention. This simultaneity is principally responsible for the advantages of the method. Concurrently means they are done substantially at the same time, not sequentially. It does not require these two simultaneous events to begin or end at exactly the same instant of time, but rather requires only substantial simultaneity. Concurrent means these two events are occurring simultaneously for a substantial majority of the time required for either event.

The final step of the method is disposing the sandwich contents on at least one of the layers of bread 18. In particular, the sandwich contents are disposed on the toasted surface of at least one of the submarine roll halves. As described, the halves are usually joined along a common edge, so the sandwich contents may extend from the toasted surface of one half to that of the other. If the layers of bread are constituted by two unjoined slices cut from a loaf of bread, or if the roll halves are not joined, then the layers should be positioned adjacently to one another prior to disposing the sandwich contents on the bread 18. This way, pieces of sandwich contents that would otherwise fall from the toasted surface are collected by the adjacently positioned toasted surface of the other layer, so they do not escape consumption. If cheese has not been placed on the sandwich contents on the griddle, then the cheese may be added after disposing the sandwich contents on the bread 18. In either case, heat from the grilled sandwich contents melts the cheese, and heat from the toasted bread melts the cheese further once the sandwich is completely assembled.

Regarding the complete assembly of the sandwich, the combination is preferably served to the consumer as an “open-faced” sandwich; it is not fully assembled for usual hand-held consumption, in which each layer of bread is aligned substantially oppositely to the other with the sandwich contents there between. The sandwich is fully assembled when the consumer places the remaining half of the roll on top of the cheese, with the toasted surface of that half contacting the cheese. By the time the sandwich is fully assembled for consumption, the sandwich contents have been in contact with the roll from at least a few minutes to as many as several minutes. However, the outer crust remains crispy and resists becoming soggy by absorbing moisture from the sandwich contents, because most of that moisture was released during grilling. Also, the outer crust is substantially thicker than a toasted surface produced by a toaster or the griddle surface, and therefore can absorb some moisture without becoming noticeably less crispy.

Additionally, the method may include a step of removing a moist byproduct, such as grease or water, from the sandwich contents during or after grilling 16. For example, the griddle may be angled for draining the moist byproduct while the sandwich contents undergo grilling 16, thereby minimizing an extent to which grease and water accumulating in the sandwich contents can be absorbed by the bread. This aids in preserving the crispness of the toasted surface on which the sandwich contents are disposed.

The present method provides several advantages. The primary advantage is that grilling 16 is performed simultaneously and concurrently with toasting 14, so the toasted bun emerges from the impinging oven to meet the grilled sandwich contents. The method can generally be performed in about one minute, which is substantially quicker than prior art methods for volume production of sandwiches. To further enhance the quickness of the method, the rear opening of the impinging oven can be positioned adjacently to the griddle, so the toasted bread emerges from the oven proximate to the griddle. Alternatively, it may be positioned next to the topping station, which is next to the griddle. This positioning facilitates the quickness with which the sandwich may be prepared by minimizing a distance the sandwich contents and the bread must be displaced from the griddle and the oven, respectively, prior to disposing the sandwich contents on the bread 18. For example, an operator can use one hand to grasp the toasted bread that is emerging from the oven, while the other hand removes the sandwich contents from the griddle using a tool such as a spatula.

Another important advantage is that the freshness of the bread is well preserved during the method. As described above, the combination of the bread initially being in the lightly baked condition, and then undergoing toasting 14 by the heated air currents of the impinging oven, surroundingly toasts the bread. As a result, the bread quickly acquires a freshly baked appearance, flavor, and texture. Also, the bread acquires the toasted crust, which generally appeals to a large number of consumers, regardless of which sandwich contents are ordered. This high-volume perception that the toasted crust consistently provides for the sandwich reliably translates into earnings. Also, Applicant's method does not require the submarine roll to touch the griddle in order to be heated and acquire the toasted crust. Thus, the roll does not become unappealing from contacting the griddle, such as by absorbing flavors and acquiring leftover pieces of foods that were previously cooked on the griddle. This assures that the consumer tastes only the flavors of the bread and the sandwich contents ordered.

While certain preferred embodiments of the present invention have been disclosed in detail, it is to be understood that various modifications may be adopted without departing from the spirit of the invention or scope of the following claims.

1. A method of making a sandwich, comprising the steps of:
(a) initiating toasting two layers of baked bread;
(b) initiating grilling sandwich contents on a griddle concurrently with said toasting; and,
(c) disposing said sandwich contents on a surface of at least one of said layers of bread.

2. The method according to claim 1, in which the toasting step is performed by impinging heated air surroundingly against said bread.

3. The method according to claim 1, in which said bread is lightly baked prior to toasting.

4. The method according to claim 1, in which said layers are constituted by two half-portions of a submarine roll.

5. The method according to claim 1, in which the toasting step is performed by conveying said bread through an impinging oven.

6. The method according to claim 1, including removing a moist byproduct from said sandwich contents prior to disposing said sandwich contents on said bread.

7. The method according to claim 1, in which the toasting step is performed by impinging heated air surroundingly against said bread while conveying said bread through an impinging oven.

8. The method according to claim 7, in which said bread is lightly baked prior to toasting.

9. The method according to claim 8, in which said layers are constituted by two half-portions of a submarine roll.

10. The method according to claim 9, including removing a moist byproduct from said sandwich contents prior to disposing said sandwich contents on said bread.
